(19) United States
(12) Patent Application Publication
(10) Pub. No.: US 2025/0012823 A1
(43) Pub. Date: Jan. 9, 2025

(54) LABORATORY SYSTEM OR DEVICE WITH IMPROVED SECURITY FEATURES AND METHOD FOR IMPROVING SECURITY IN A LABORATORY SYSTEM OR DEVICE

(71) Applicant: Roche Molecular Systems, Inc., Pleasanton, CA (US)

(72) Inventors: Michal Karol Dobrzynski, Aargau (CH); Paul Federer, Lucerne (CH); Ivo Daniel Vicente Leitao, Zug (CH); Stefan Vollenweider, Aargau (CH)

(21) Appl. No.: 18/711,539

(22) PCT Filed: Nov. 17, 2022
(86) PCT No.: PCT/EP2022/082212

§ 371 Date: May 17, 2024

(30) Foreign Application Priority Data
Nov. 18, 2021 (EP) 21208938.7

(51) Int. Cl. G01N 35/00; G01N 35/04; G01N 35/10

(52) U.S. Cl. CPC G01N 35/0099; G01N 35/1002; G01N 2035/00316; G01N 2035/0498

(57) ABSTRACT

A method for increasing operational security of a laboratory system or device comprising: a reagent storage area (1) comprising at least two reagent drawers (2, 3) mounted slidably along a first axis Y between an open position (O) and a closed position (C) and arranged stacked with respect to a second axis Z perpendicular to the first axis Y, and having each a position sensor (P2, P3) for determining the closed position (C) of the respective reagent drawer (2, 3), at least one robotic handler head (4) movably arranged in the reagent storage area at least along the first axis Y and the second axis Z a control unit (5) configured to control the operation of the robotic handler head (4) and connected to the position sensors (P2, P3), the method comprising the steps of defining for each reagent drawer (2, 3) a first forbidden zone along the first axis Y (Y) and a second forbidden along the second axis Z (Z2, Z3), determining by means of the position sensors (P2, P3) if the reagent storage drawers (2, 3) are in the closed position (C), and control the operation of the handler head (4).

### FIELD OF THE INVENTION

The invention relates to a laboratory system or device with improved security and a method for improving security in a laboratory system or device.

### BACKGROUND

In fully automated laboratory systems and devices, there is the desire to increase the throughput while minimizing the hands-on time by an operator. In particular, laboratory systems and devices shall provide «random access» and «continuous loading» of samples and supplies, e.g. consumables, reagents, controls etc. Under circumstances, an operator should be able to load and unload samples and supplies at any point of time

A solution consists in dedicated loading/unloading areas for single samples, as well as supplies for processing single samples (such as a cartridge containing all reagents for processing a single sample). However, single sample processing is typically associated with high cost per test, and in low throughput per analyzer of a certain size. This is particularly the case if the process involves a long process step as PCR. To reduce cost per test, reagents are often provided in containers or cartridges containing all the reagents necessary for performing a given assay which can be used for a larger number of tests, and samples are processed in batches of typically 5 to 96 samples.

If the same test is performed for all samples of a batch, then only one set of test-specific reagents is required for this batch. If several tests are performed within a batch, then several sets of test-specific reagents must be available. Typically, a laboratory has a menu of several different tests that are performed on a daily basis on the same laboratory system or analyzer. In order to minimize the daily hands-on time for users to load and unload reagents, and maximize the walk-away time, it is desirable to store all commonly used assay-specific reagents on board of the analyzer. Furthermore, the on-board storage must be temperature-controlled in order to ensure reagent stability within the specified maximum storage duration.

In order to achieve sufficient throughput, the batches of samples are processed in an interleaved mode. This means that when a batch run starts, the next batch is already being processed.

Therefore, the laboratory system has to ensure that the specific reagents for both batch runs are available. In some cases, more than two batch runs may be running (although not simultaneously) in an interleaved mode.

It is therefore clear that a plurality of reagent cartridges has to be available during operation of the laboratory system or device. However, the available space is limited by different factors. There is therefore the need to improve reagent handling in known laboratory systems and devices.

In addition, the reagent cartridges are often stored on the system or device in receptacles and drawers of a reagent storage zone that need to be locked most of the time in order to prevent injuries of an operator, since the reagent cartridges are often transferred from and to the reagent storage zone by robotic handlers. In addition, a reagent cartridge should often be available at any time when the batch run is being processed.

As a consequence, an operator may have a very limited access to the reagent storage zone. In the case where the operator shall be given a maximal amount of access to the reagent drawers, it shall be ensured that the security of the operator is guaranteed, since the robotic handlers used may be a potential danger for an operator, in particular when reaching inside the reagent drawer with an hand or arm.

It is therefore aim of the present invention to provide a laboratory system or device with improved security and a method for improving security in a laboratory system or device which allows an optimal loading/unloading of reagent cartridges while the system or device is being operated and at the same time provides maximal security for an operator.

This is achieved by a laboratory system or device and by a method according to the independent claims.

As used in the following, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically will be used only once when introducing the respective feature or element. In the following, in most cases, when referring to the respective feature or element, the expressions “at least one” or “one or more” will not be repeated, non-withstanding the fact that the respective feature or element may be present once or more than once.

Further, as used in the following, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such way with other optional or non-optional features of the invention.

According to the method for increasing operational security of a laboratory system or device, the laboratory system or device comprises a reagent storage area comprising at least two reagent drawers mounted slidably along a first axis Y between an open position and a closed position.

The first reagent drawer is arranged above the second reagent drawer with respect to a second axis Z perpendicular to the first axis Y.

Each reagent drawer is associated with a position sensor for determining the closed position of the respective reagent drawer.

The position sensors may be arranged on the reagent drawers or in the reagent storage area. In a preferred embodiment, the position sensors are realized as a light barrier.

The system or device further comprises at least one robotic handler head movably arranged in the reagent storage area at least along the first axis Y and the second axis Z.

The system or device further comprises a control unit a control unit configured to control the operation of the robotic handler head and connected to the position sensors.

According to the method of the present invention, the following steps are performed.

In a first step, for each reagent drawer, a first forbidden zone along the first axis Y and a second forbidden zone along the second axis Z is defined. This definition may be already implemented by the manufacturer and stored in a data storage connected to the control unit or may be alternatively or simultaneously implemented as a hardware logic in the laboratory device for security, robustness and redundancy.

In a second step, the control unit determines by means of the position sensors if the reagent storage drawers are in the closed position. This is done by checking the respective position sensor associated with the reagent drawer. It is therefore not necessary to determine if the reagent drawer is in the open position. For security reasons, a reagent which is determined as being not closed (even if it is slightly open, e.g. just a couple of millimeters) has the same security impact as a reagent drawer which is in the open position.

Then, if the position determination is successful, meaning that the reagent drawers are both in the closed position, the control unit controls the operation of the handler head. In this regard it should be noted that controlling the operation of the handler head does not necessarily means that the control unit is capable to steer the movement of the handler head, for the purpose of the present invention it is only necessary that the control unit is configured to allow the handler head to be operated or stop the operation of the handler head, as will be described below in more detail.

If however the closed position determination is unsuccessful, the control unit determines by means of the position sensors which reagent drawer of the at least two reagent drawers is not in the closed position. In the following description it will be assumed that reagent drawer 2 is determined as not being in the closed position by position sensor P2.

The control unit then determines a position of the robotic handler head along the first axis Y and the second axis Z.

In a subsequent step, the control unit then determines if the position of the robotic handler head along the first axis Y is within the first forbidden zone (in this example Y2) and the position of the handler head along the second axis Z is within the second forbidden zone (in this example Z2) that are associated with the reagent drawer (in this example reagent drawer 2) that has been determined as being not in the closed position.

If it has been determined that the position of the robotic handler head along the first axis Y is within the first forbidden zone (Y2) and the position of the handler head along the second axis Z is within the second forbidden zone (Z2) associated with the reagent drawer (reagent drawer 2) not in the closed position, the control unit then stops the operation of the robotic handler head, preferably by interrupting energy supply to the actuators, more preferred all the actuators, of the robotic handler head.

In the following, the case where both reagent drawers are determined as not being in the closed position will be explained.

If the closed position determination is unsuccessful and the control unit determines that both reagent drawers are not in the closed position, the control unit determines a position of the robotic handler head along the first axis Y and the second axis Z as in the previous example.

Then, the control unit determines if the position of the robotic handler head along the first axis Y is within the first forbidden zone and the position of the handler head along the second axis Z is within the second forbidden zone associated with both reagent drawers.

In this regard, the first forbidden zone associated with both reagent drawers is defined as a zone formed by overlapping the first forbidden zone Y2 associated with the first reagent drawer 2 with the first forbidden zone Y3 associated with the second reagent drawer 3. Analogously, the second forbidden zone associated with both reagent drawers is defined as a zone formed by overlapping the second forbidden zone Z2 associated with the first reagent drawer 2 with the second forbidden zone Z3 associated with the second reagent drawer 3.

The control unit is in this case configured to stop the operation of the robotic handler head if it has been determined that the position of the robotic handler head along the first axis Y is within the first forbidden zone and the position of the handler head along the second axis Z is within the second forbidden zone associated with both reagent drawers.

With such a method, the security of a laboratory system or device can be drastically increased in a simple, robust and redundant way.

It should be clear that the above description applies accordingly to a laboratory system or device according to the present invention.

### SHORT DESCRIPTION OF THE FIGURES

FIG. 1 depicts schematically a sectional view of a laboratory system or device according to the present invention with the first reagent drawer not in the closed position,

FIG. 2 depicts schematically a sectional view of a laboratory system or device according to the present invention with the second reagent drawer not in the closed position, and

FIG. 3 depicts schematically a sectional view of a laboratory system or device according to the present invention with both reagent drawers not in the closed position.

### DETAILED DESCRIPTION OF THE FIGURES

The invention will be described now by way of preferred embodiments in connection with the drawings.

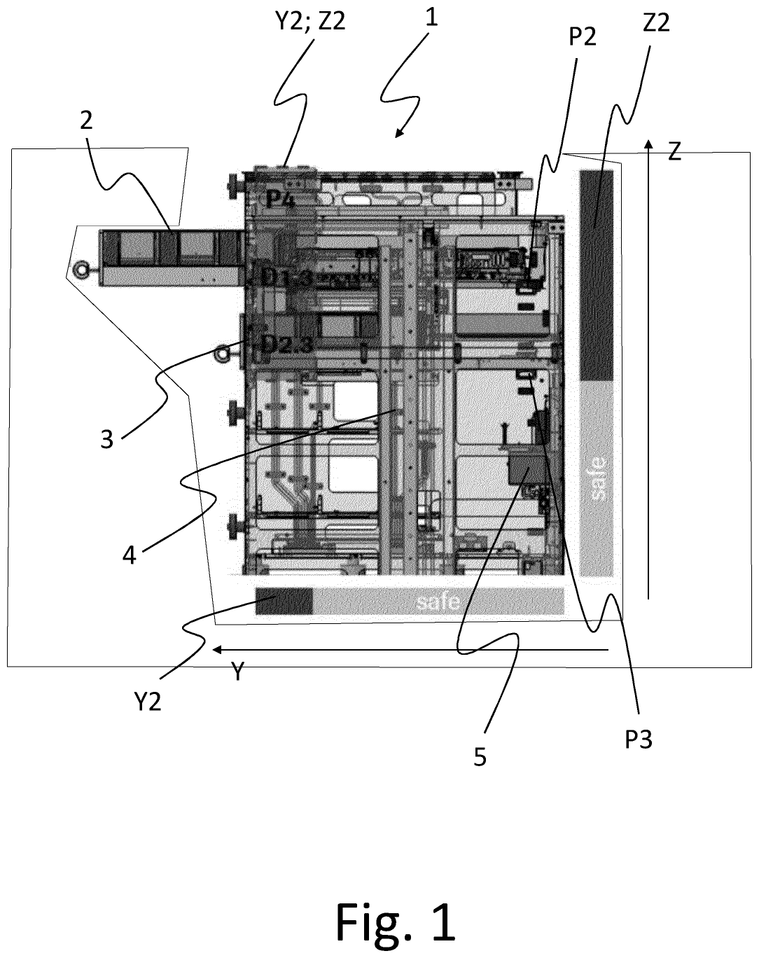

In FIG. 1, the reagent storage area 1 of a laboratory system or device is shown in a schematically sectional view. A first reagent drawer 2 is arranged above a second reagent drawer 3, wherein the first reagent drawer is in the open position. The reagent drawers 2 and 3 are slidably arranged within the reagent storage area 1 along a first axis Y. Each reagent drawer 2 and 3 is associated with a position sensor P2 and P3 to determine of the associated drawer is in the closed position.

A robotic handler, schematically shown as 4, is also arranged within the reagent storage area 1 and is movable along the first axis Y and a second axis Z.

A control unit 5 configured to control the operation of the robotic handler head 4 and connected to the position sensors P2 and P3 is also arranged within the reagent storage area 1.

The forbidden zones Y2 and Z2 associated with the first reagent drawer 2 are shown near the respective axis Y and Z.

Since the first reagent drawer 2 is open, the control unit 5 determines by means of the position sensor P2 that the first reagent drawer 2 is not closed. Therefore, the area Y2; Z2 is determined as a forbidden area for the robotic handler head 4. The control unit 5 therefore only allows operation of the robotic handler head 4 outside of the forbidden area Y2; Z2. As soon as the control unit 5 determines that the robotic handler head 4 is within the forbidden area Y2; Z2, operation of the robotic handler 4 head is stopped.

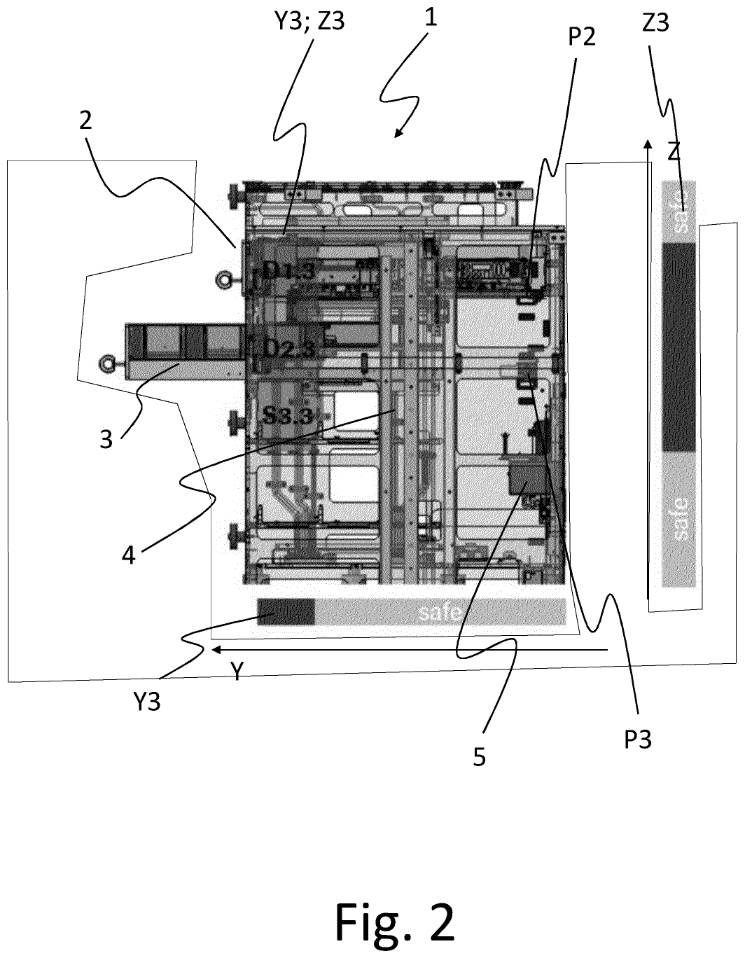

In FIG. 2, a similar situation to the one depicted in FIG. 1 is shown, however with the second reagent drawer 3 in the open position and the first reagent drawer 2 in the closed position.

The forbidden zones Y3 and Z3 associated with the second reagent drawer 3 are shown near the respective axis Y and Z.

Since the second reagent drawer 3 is open, the control unit 5 determines by means of the position sensor P3 that the second reagent drawer 3 is not closed. Therefore, the area Y3; Z3 is determined as a forbidden area for the robotic handler head 4. The control unit 5 therefore only allows operation of the robotic handler head outside of the forbidden area Y3; Z3. As soon as the control unit 5 determines that the robotic handler head 4 is within the forbidden area Y3; Z3, operation of the robotic handler head 4 is stopped.

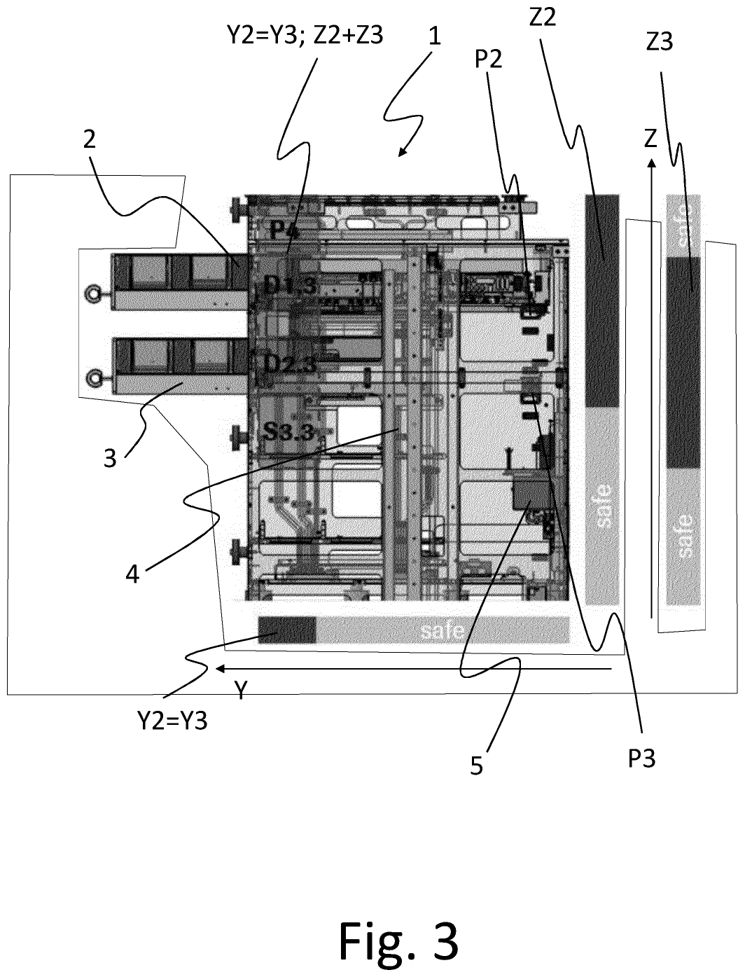

In FIG. 3, a similar situation to the one depicted in FIGS. 1 and 2 is shown, however with the both the first reagent drawer 2 and the second reagent drawer 3 in the open position.

The forbidden zones Y2 and Z2 associated with the first reagent drawer 2 are shown near the respective axis Y and Z. Analogously, the forbidden zones Y3 and Z3 associated with the second reagent drawer 3 are also shown near the respective axis Y and Z. In this example the forbidden zones Y2 and Y3 are identical, and therefore only one block is shown. In other cases, the forbidden zones may not be identical or may have the same size, but be shifted as in the case of the forbidden zones Z2 and Z3.

Since both the first reagdent drawer 2 and the second reagent drawer 3 are open, the control unit 5 determines by means of the position sensors P2 and P3 that both the first reagent drawer and the second reagent drawer 3 are not closed. Therefore, the area Y2=Y3; Z2,Z3 is determined as a forbidden area for the robotic handler head 4. The control unit 5 therefore only allows operation of the robotic handler head outside of the forbidden area Y2=Y3; Z2,Z3. As soon as the control unit 5 determines that the robotic handler head 4 is within the forbidden area Y2=Y3; Z2,Z3, operation of the robotic handler head 4 is stopped.

1. A method for increasing operational security of a laboratory system, the laboratory system comprising:
a reagent storage area comprising at least two reagent drawers mounted slidably along a first axis Y between an open position and a closed position, a first reagent drawer of the at least two reagent drawers being arranged above a second reagent drawer of the at least two reagent drawers, with respect to a second axis Z perpendicular to the first axis Y, and each being associated with a position sensor for determining the closed position of the respective reagent drawer,
at least one robotic handler head movably arranged in the reagent storage area at least along the first axis Y and the second axis Z, and
a control unit configured to control the operation of the robotic handler head and connected to the position sensors,
the method comprising the following steps:
defining for each reagent drawer a first forbidden zone along the first axis Y and a second forbidden zone along the second axis Z,
the control unit determining by means of the position sensors if the reagent storage drawers are in the closed position, and
the control unit, if the closed position determination is successful, controlling the operation of the handler head.

2. The method of claim 1, wherein the control unit further performs the steps of:
if the closed position determination is unsuccessful, determining which reagent drawer of the at least two reagent drawers is not in the closed position,
determining a position of the robotic handler head along the first axis Y and the second axis Z,
determining if the position of the robotic handler head along the first axis Y is within the first forbidden zone and the position of the handler head along the second axis Z is within the second forbidden zone associated with the reagent drawer not in the closed position, and
stopping the operation of the robotic handler head if it has been determined that the position of the robotic handler head along the first axis Y is within the first forbidden zone and the position of the handler head along the second axis Z is within the second forbidden zone associated with the reagent drawer not in the closed position.

3. The method of claim 2, wherein the control unit further performs the steps of:
if the closed position determination is unsuccessful and the control unit determines that both reagent drawers are not in the closed position,
determining a position of the robotic handler head along the first axis Y and the second axis Z,
determining if the position of the robotic handler head along the first axis Y is within the first forbidden zone and the position of the handler head along the second axis Z is within the second forbidden zone associated with both reagent drawers, and
stopping the operation of the robotic handler head if it has been determined that the position of the robotic handler head along the first axis Y is within the first forbidden zone and the position of the handler head along the second axis Z is within the second forbidden zone associated with both reagent drawers.

4. A laboratory system comprising:
a reagent storage area comprising at least two reagent drawers mounted slidably along a first axis Y between an open position and a closed position, a first reagent drawer of the at least two reagent drawers being arranged above a second reagent drawer of the at least two reagent drawers, with respect to a second axis Z perpendicular to the first axis Y, and each being associated with a position sensor for determining the closed position of the respective reagent drawer,
at least one robotic handler head movably arranged in the reagent storage area at least along the first axis Y and the second axis Z, and
a control unit configured to control the operation of the robotic handler head and connected to the position sensors;
wherein,
for each reagent drawer a first forbidden zone along the first axis Y and a second forbidden zone along the second axis Z is defined, and
the control unit is configured to:
determine by means of the position sensors if the reagent storage drawers are in the closed position, and
if the closed position determination is successful, control the operation of the handler head.

5. The system according to claim 4, wherein the control unit is further configured to:
if the closed position determination is unsuccessful, determine which reagent drawer of the at least two reagent drawers is not in the closed position,
determine a position of the robotic handler head along the first axis Y and the second axis Z,
determine if the position of the robotic handler head along the first axis Y is within the first forbidden zone and the position of the handler head along the second axis Z is within the second forbidden zone associated with the reagent drawer not in the closed position, and
stop the operation of the robotic handler head if it has been determined that the position of the robotic handler head along the first axis Y is within the first forbidden zone and the position of the handler head along the second axis Z is within the second forbidden zone associated with the reagent drawer not in the closed position.

6. The system according to claim 4, wherein the control unit is further configured to:
if the closed position determination is unsuccessful and the control unit determines that both reagent drawers are not in the closed position,
determine a position of the robotic handler head along the first axis Y and the second axis Z,
determine if the position of the robotic handler head along the first axis Y is within the first forbidden zone and the position of the handler head along the second axis Z is within the second forbidden zone associated with both reagent drawers, and
stop the operation of the robotic handler head if it has been determined that the position of the robotic handler head along the first axis Y is within the first forbidden zone and the position of the handler head along the second axis Z is within the second forbidden zone associated with both reagent drawers.
